(19) United States
(12) Patent Application Publication
(10) Pub. No.: US 2003/0213335 A1
(43) Pub. Date: Nov. 20, 2003

(54) Device for the rotary slaving of a crankshaft

(76) Inventor: Dipl.-Ing. Alfred Heimann, Aachen (DE)

Correspondence Address: PROSKAUER ROSE LLP, PATENT DEPARTMENT, 1585 BROADWAY, NEW YORK, NY, 10036-8299, US

(21) Appl. No.: 10/376,005

(22) Filed: Feb. 28, 2003

(30) Foreign Application Priority Data
Mar. 2, 2002 (DE) 102 09 300.8

(51) Int. Cl. F16C 3/06

(52) U.S. Cl. 74/595

(57) ABSTRACT

The present invention relates to a device (1) for the rotating slaving of a crankshaft (2) that is held at its two axial ends (3, 4) respectively between centers (5, 6) of a metal-removing machine tool and is equipped with a surface plate (7). Slaving is achieved by a slaving system (8) that is connected to the surface plate (7) or that can be connected thereto, extends parallel to the rotational axis (9) of the crankshaft (2) and is provided at its free end with a slaving body 913) attacking at a lifting journal (14) of the crankshaft (2).

The present invention relates to a device for the rotary slaving of a crankshaft that is seated with its two axial ends between centers of a metal removing machine tool and is equipped with a surface plate.

For the finishing of crankshafts, clamping between centers is advantageous so that the required concentric running and run-out precision of the different parts or segments of the crankshaft can be maintained. Clamping between centers is however very unstable for metal removing work, especially for continuous cutting; the crankshaft oscillates during the machining and becomes unacceptably wavy and imprecise. In the context of the present invention, metal-removing machining is understood to be lathing, milling or turn broaching.

Metal-removing machining of a crankshaft held in a chuck is considerably stiffer. As long as the parts normally used to hold the crankshaft such as e.g. journal or flange, have not yet been finished, the utilization of normal chucks that would provide much stiffer clamping, is not possible. One possibility would be the utilization of compensation chucks that would be able to clamp within a precision range of 10μ.

This leads to the object of the invention, i.e. to achieve slaving of a crankshaft held between centers as much as possible in such manner that no unnecessary forces act upon the crankshaft and cause deformation in it that could affect the precision of the machined crankshaft. Above all, slaving should be simple, reliable in operation and economical.

To attain this objective, a type of slaving is proposed that is connected or can be connected to the surface plate of a machine tool, extends parallel to the axis of rotation of the crankshaft at a lateral distance from the axis of rotation, and is provided at its free end with a slaving body that attacks at a lifting journal of the crankshaft.

The slaving system can either be permanently and fixedly connected to the surface plate of the machine tool or, as required, can be connected temporarily to the surface plate. In this case it is advantageous if the slaving system attacks not at a bearing of the crankshaft at the end but as much as possible at a lifting journal located in the axial center of the crankshaft. The slaving system is designed so that the surfaces or segments of the crankshaft to be finished by machining, e.g. the alignment bearings, the flange, the crank arms, are not covered up by the slaving system. The invention is provided in particular to machine the alignment bearings of a crankshaft or to perform additional work on the flange or end journal of the crankshaft. It is advantageous if the slaving device is so firm or is so well balanced (this being technically better and therefore more economical) that no considerable centrifugal forces and thereby radial shifting occur on the crankshaft at the rotational speeds of metal removing. It is also advantageous if the slaving system has at least three times the flexural strength of the crankshaft.

In an advantageous embodiment the slaving system is provided with a clamping that tangentially clamps the lifting journal into which the slaving force is introduced and thus connects the crankshaft in tangential and radial direction to the slaving system, whereby the entire crankshaft and slaving system is given added firmness. Clamping can be effected from the outside by a power element using pressure means. An especially simple type of slaving s achieved in fact by a lever that clamps the crankshaft under the influence of the centrifugal force of the rotating slaving system. In this manner assurance is provided that no radial displacements can occur on the crankshaft as a result of clamping.

The invention is described in further detail below through an example of an embodiment:.

Not to scale and greatly simplified:

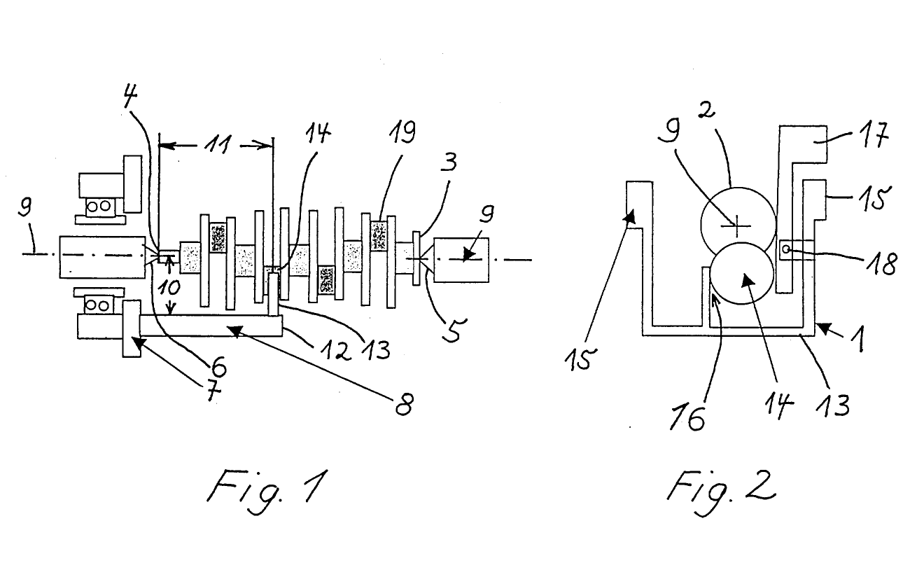

FIG. 1 shows a device in a lateral view and

FIG. 1 shows a device in a frontal view.

A crankshaft 2 is held by its two axial ends 3 and 4 respectively between centers 5 and 6 of a metal-removing machine tool (not shown). The machine tool is provided with a surface plate 7. The device 1 for the rotary slaving of the crankshaft 2 is provided with a slaving system 8 that is either permanently and fixedly connected to the surface plate 7 of the machine tool (not shown) or can be connected to it temporarily.

The slaving system 8 extends parallel to the rotational axis 9 of the crankshaft 2 over a segment 11 of the length of the crankshaft 2. It is laterally at a distance 10 from the rotational axis 9 and has a slaving body 13 at its free end 12 attacking the crankshaft 2. The longitudinal segment 11 can however be selected longer or shorter, depending on the requirements of the machining conditions.

In order to avoid imbalance that could be caused in the machine tool by the rotating slaving system 8, compensation masses 15 are provided. The slaving body 13 of the slaving system 8 has a sliding surface 16 against which the lifting journal 14 of the crankshaft 2 comes to lie as the slaving system rotates.

In additional to slaving via the contact surface 16, clamping of the lifting journal 14 at the slaving body 13 can be provided. Such clamping can be in form of a power element (not shown) that can be supplied from the outside by a pressure medium, e.g. pressure oil or compressed air. A truly simple type of slaving results from a clamping lever 17 actuated by centrifugal force. As the slaving body 13 rotates, the clamping lever 17 produces a clamping moment around its fulcrum 18. Under normal chip removing forces, this centrifugal-force clamping by the clamping lever 17 is entirely sufficient for the slaving of the crankshaft 2.

Instead slaving via a lifting journal 14 located in the center of the crankshaft, it is also possible to slave via a lifting journal 19 located closer to one of the outer ends 3, 4 of the crankshaft 2. For this purpose the invention provides that the axial length 11 of the slaving system 8 is adjustable.

1. Device (1) for the rotating slaving of a crankshaft (2) held at its axial ends (3, 4) respectively between centers (5, 6) of a metal-removing machine tool, provided with a surface plate (7), characterized by
a slaving system (8) that
is connected or can be connected to the surface plate (7),
extends parallel to the rotational axi (9) of the crankshaft (2) at a lateral distance (10) from the rotational axis (9) over a segment (11) of the length of the crankshaft (2) and provided at its free end (12)
with a slaving body (13) attacking at a lifting journal (14) of the crankshaft (2).

2. Device as in claim 1, characterized in that the slaving system (8) extends nearly over one half of the axial length of the crankshaft (2).

3. Device as in one of the claims 1 or 2, characterized in that the slaving system (8) is provided with compensation masses (15).

4. Device as in claim 1, characterized in that the slaving body (13) is provided with at least one sliding surface (16) for the lifting journal (14).

5. Device as in claim 4, characterized in that the slaving body (13) is provided with a clamping device for the lifting journal (14) of the crankshaft (2)

6. Device as in claim 5, characterized in that the clamping device is a power element that can be supplied with a pressure medium.

7. Device as in claim 5, characterized in that the clamping device is clamping a lever (17) actuated by centrifugal force.

8. Device as in claim 1, characterized in that the axial length (11) of the slaving system (8) can be changed.
